(19) United States
(12) Patent Application Publication
(10) Pub. No.: US 2020/0340808 A1
(43) Pub. Date: Oct. 29, 2020

(54) DISTANCE MEASURING CAMERA

(71) Applicant: MITSUMI ELECTRIC CO., LTD., Tokyo (JP)

(72) Inventor: Teruhiko OZUCHI, Tokyo (JP)

(21) Appl. No.: 16/762,453

(22) PCT Filed: Oct. 23, 2018
(86) PCT No.: PCT/JP2018/039346

§ 371 Date: May 7, 2020

(30) Foreign Application Priority Data
Nov. 10, 2017 (JP) 2017-217669

(51) Int. Cl. G01C 3/06; G02B 7/32; G06T 7/507

(52) U.S. Cl. CPC G01C 3/06; G06T 7/507; G02B 7/32

(57) ABSTRACT

A distance measuring camera 1 includes a light beam irradiation unit 3 for irradiating a light beam B3 with respect to a subject, an imaging unit 4 for photographing the subject to which the light beam B3 is irradiated to obtain an image and a distance calculating part 6 for calculating a distance to the subject based on a size of the light beam B3 on the subject contained in the image obtained by the imaging unit.

### TECHNICAL FIELD

The present invention generally relates to distance measuring cameras for calculating a distance to a subject, in particular to a distance measuring camera for calculating a distance to a subject based on a size of a light beam on the subject contained in an image obtained by irradiating the light beam with respect to the subject and photographing the subject to which the light beam is irradiated.

### BACKGROUND ART

In recent years, there is proposed a distance measuring camera which can obtain an image of a subject and measure a distance to the subject. As such a distance measuring camera, there is known a stereo camera type distance measuring camera including two or more pairs of an imaging optical system for forming an image of light from a subject and an image sensor for converting the image of the subject formed by the imaging optical system to an image signal (for example, see patent document 1). Further, there is also known an active stereo type distance measuring camera in which a projector for projecting a constant pattern (such as a grid pattern) of light onto a subject and an imaging system for obtaining an image of the subject to which the constant pattern of the light is irradiated are arranged so as to be spaced apart from each other in a left and right direction and which can calculate a distance to the subject based on changes in positions of component elements (such as dots and slits) of the constant pattern contained in the image obtained by the imaging system (for example, see patent document 2).

In the stereo camera type distance measuring camera, the two or more pairs of the imaging optical system and the image sensor are used to obtain a plurality of images having different disparities and the distance to the subject is calculated based on the disparities among the plurality of obtained images. Therefore, the stereo camera type distance measuring camera needs to use two or more imaging systems. Providing the two or more imaging systems in one distance measuring camera causes problems such as increase in complexity of a configuration of the distance measuring camera, increase in a size of the distance measuring camera and increase in a cost of the distance measuring camera. Further, in order to accurately calculate the distance to the subject, it is required to obtain a large disparity. Therefore, it is required to arrange the two or more imaging systems with being spaced significantly apart from each other in one distance measuring camera. For this reason, the size of the distance measuring camera increases.

In the active stereo type distance measuring camera, one of the two imaging systems of the stereo type distance measuring camera is replaced with the projector that irradiates the constant pattern with respect to the subject and the distance to the subject is calculated by photographing the subject to which the constant pattern is irradiated with the remaining imaging system. In the active stereo type distance measuring camera, since the imaging system and the projector are arranged so as to be spaced apart from each other in the left and right direction, the positions of the component elements (such as dots and slits) of the pattern contained in the obtained image change in accordance with the distance to the subject. Therefore, the active stereo type distance measuring camera can calculate the distance to the subject by detecting the positions of the component elements of the pattern contained in the obtained image. However, even in such an active stereo type distance measuring camera, in order to accurately calculate the distance to the subject, it is necessary to increase the changes in the positions of the component elements of the pattern according to the distance to the subject. Therefore, it is necessary to arrange the imaging system and the projector with being spaced significantly apart from each other in one distance measuring camera. This results in the increase in the size of the distance measuring camera.

As described above, since it is necessary to arrange the two imaging systems or the imaging system and the projector with being spaced significantly apart from each other in order to accurately calculate the distance to the subject, the conventional distance measuring camera has a problem that it is difficult to downsize the distance measuring camera.

### RELATED ART DOCUMENTS

### Patent Documents

[Patent Document 1] JP 2013-257162A

[Patent Document 2] JP 2017-53812A

### SUMMARY OF THE INVENTION

### Problems to be Solved by the Invention

The present invention has been made in view of the above problems of the conventional arts mentioned above. Accordingly, it is an object of the present invention to provide a distance measuring camera which can calculate a distance to a subject without using any disparity and can be downsized.

### Means for Solving the Problems

The above object is achieved by the present inventions defined in the following (1) to (9).

A distance measuring camera, comprising;
a light beam irradiation unit for irradiating a light beam with respect to a subject;
an imaging unit for photographing the subject to which the light beam is irradiated to obtain an image; and
a distance calculating part for calculating a distance to the subject based on a size of the light beam on the subject contained in the image obtained by the imaging unit.

(2) The distance measuring camera according to the above (1), further comprising an association information storage part for storing association information for associating the size of the light beam on the subject contained in the image with the distance to the subject to which the light beam is irradiated,
wherein the distance calculating part calculates the distance to the subject based on the size of the light beam on the subject contained in the image and the association information stored in the association information storage part.

(3) The distance measuring camera according to the above (1) or (2), wherein the light beam irradiated with respect to the subject from the light beam irradiating unit is a light beam that diffuses or converges with a light distribution angle which is different from a light converging angle of an imaging optical system of the imaging unit or a collimated light beam.

(4) The distance measuring camera according to the above (3), wherein the light beam irradiation unit includes:
a light source for irradiating a single light beam,
light beam diffusing means configured to receive the single light beam irradiated from the light source and emit a diffusing light beam, and
light distribution angle changing means configured to change a light distribution angle of the diffusing light beam emitted from the light beam diffusing means and emit the light beam that diffuses or converges with the light distribution angle which is different from the light converging angle of the imaging optical system of the imaging unit or the collimated light beam.

(5) The distance measuring camera according to the above (4), wherein the light beam diffusing means is a first diffraction grating configured to convert the single light beam into the diffusing light beam, and
the light distribution angle changing means is a second diffraction grating configured to change the light distribution angle of the diffusing light beam and emit the light beam that diffuses or converges with the light distribution angle which is different from the light converging angle of the imaging optical system of the imaging unit or a collimating lens configured to emit the collimated light beam.

(6) The distance measuring camera according to the above (4) or (5), wherein the imaging unit and the light beam irradiation unit are arranged close to each other so that an optical axis of the imaging optical system of the imaging unit and an optical axis of the light source of the light beam irradiation unit are parallel to each other.

(7) The distance measuring camera according to any one of the above (1) to (6), wherein the light beam is a near-infrared light beam.

(8) The distance measuring camera according to any one of the above (1) to (7), wherein the light beam irradiating unit is configured to irradiate a plurality of light beams with respect to the subject.

(9) The distance measuring camera according to the above (8), wherein the plurality of light beams are irradiated so as to form a concentric circle pattern or a grid pattern.

### Effect of the Invention

According to the distance measuring camera of the present invention, it is possible to calculate the distance to the subject based on the size of the light beam on the subject contained in the obtained image. Since the distance measuring camera of the present invention does not use any disparity in order to calculate the distance to the subject, it is possible to arrange the imaging unit for photographing the subject and the light beam irradiation unit for irradiating the light beam with respect to the subject with being close to each other. Therefore, as compared with the conventional distance measuring camera in which a plurality of imaging systems or an imaging system and a projector need to be arranged with being spaced significantly apart from each other, it is possible to downsize the distance measuring camera of the present invention.

### BRIEF DESCRITION OF THE DRAWINGS

FIG. 1 is a block diagram schematically showing a distance measuring camera according to a first embodiment of the present invention.

FIG. 2 is a diagram for showing a configuration of a light beam irradiation unit of the distance measuring camera shown in FIG. 1.

FIG. 3 is a diagram for explaining a principle of a distance measuring method used in the distance measuring camera shown in FIG. 1. FIG. 3(a) shows a light beam irradiated with respect to a subject when a light converging angle θ of an imaging optical system of an imaging unit is equal to a light distribution angle φ of diffusion of the light beam (θ=φ). FIG. 3(b) shows an example in which the subject is irradiated with a collimated light beam. FIG. 3(c) shows an example in which a light beam converging with the light distribution angle φ which is different from the light converging angle θ of the imaging optical system of the imaging unit is irradiated with respect to the subject. FIG. 3(d) shows an example in which the light beam diffusing with the light distribution angle φ which is different from the light converging angle θ of the imaging optical system of the imaging unit is irradiated with respect to the subject.

FIG. 4 is a diagram for explaining a relationship between a size of a collimated light beam contained in an image obtained by irradiating the collimated light beam with respect to the subject and photographing the subject and the distance to the subject.

FIG. 5 is a diagram for explaining the relationship between the size of the collimated light beam contained in the image obtained by irradiating the collimated light beam with respect to the subject and photographing the subject and the distance to the subject. FIG. 5(a) shows an image obtained by photographing a subject positioned at a distance 1 which is closest to the subject from the imaging optical system of the imaging unit. FIG. 5(b) shows an image obtained by photographing a subject positioned at a distance 2 from the subject to the imaging optical system, which is larger than the distance 1. FIG. 5(c) shows an image obtained by photographing a subject positioned at a distance 3 from the subject to the imaging optical system of the imaging unit, which is larger than the distance 2. FIG. 5(d) shows an image obtained by photographing a subject positioned at a distance 4 from the subject to the imaging optical system of the imaging unit, which is larger than the distance 3.

FIG. 6 is a diagram for explaining a relationship between a change in a shape of the light beam in the obtained image and a change in the distance to the subject. FIG. 6(a) shows an example of the change in the shape of the light beam in the image when a depth of the subject discontinuously changes in an area of the subject where the light beam is irradiated. FIG. 6(b) shows an example of the change in the shape of the light beam in the image when the depth of the subject continuously changes in the area where the light beam of the subject is irradiated.

FIG. 7 is a diagram showing the configuration of the light beam irradiation unit of the distance measuring camera according to a second embodiment of the present invention.

FIG. 8 is a diagram showing an example of a pattern of light beams irradiated with respect to the subject in the distance measuring camera shown in FIG. 7. FIG. 8(a) shows an example in which a plurality of light beams form a concentric circle pattern in an image. FIG. 8(b) shows an example in which a plurality of light beams form a grid pattern in the image. FIG. 8(c) shows an example in which a pattern of light beams is illuminated with respect to only seats where occupants are to be seated.

FIG. 9 is a flow chart illustrating the distance measuring method performed by using the distance measuring camera of the present invention.

FIG. 10 is a diagram showing an application example in which the distance measuring camera according to the second embodiment of the present invention is applied for an occupant detection system in a vehicle.

### DETAILED DESCRIPTION OF THE PREFERRED EMBODIMENTS

Hereinafter, a distance measuring camera of the present invention will be described based on preferred embodiments shown in the accompanying drawings.

### First Embodiment

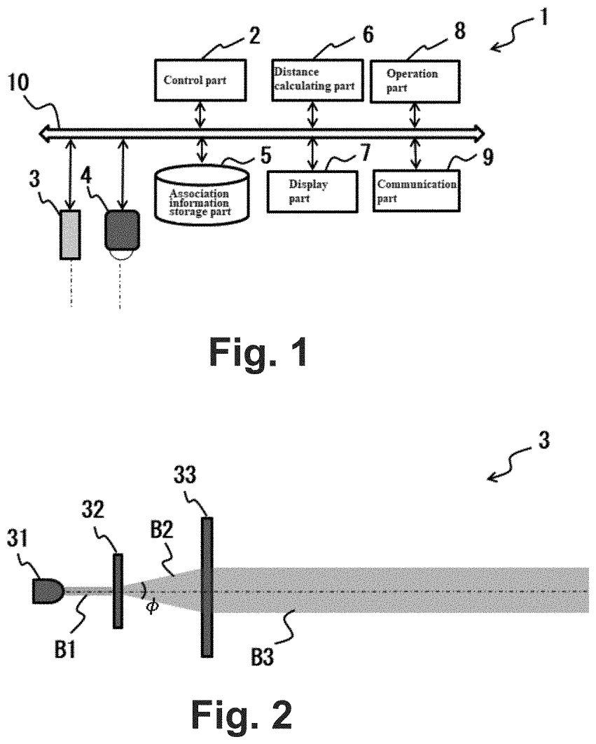

First, referring to FIG. 1 to FIG. 6, a distance measuring camera according to a first embodiment of the present invention will be described in detail.

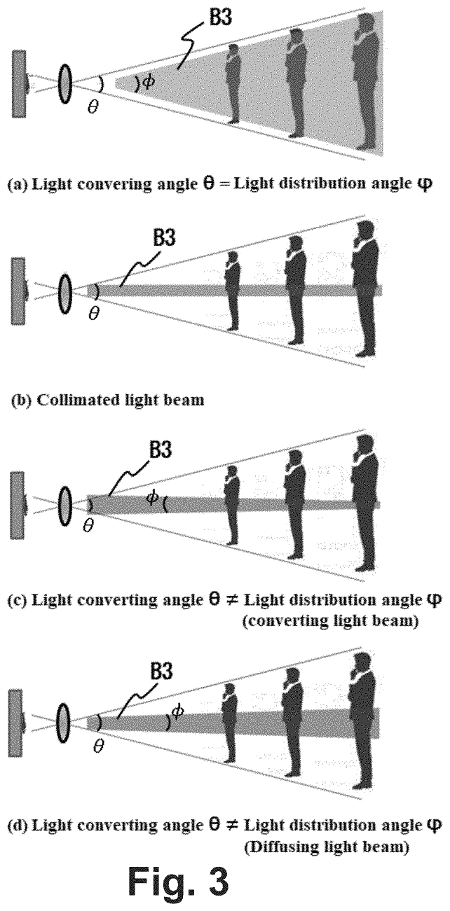

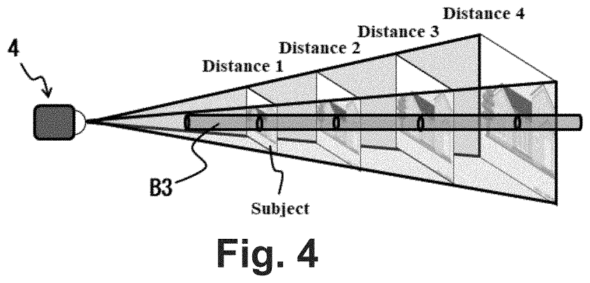

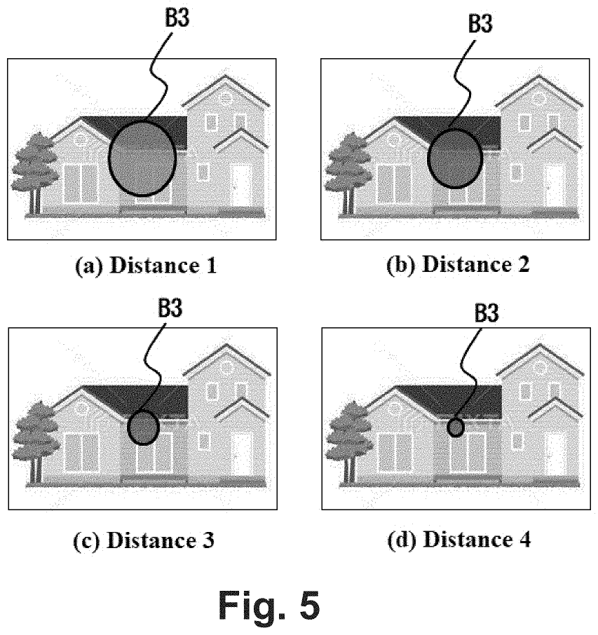

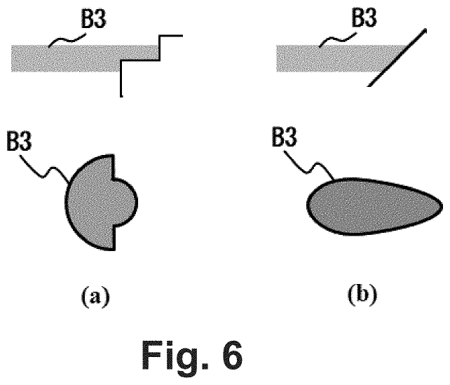

FIG. 1 is a block diagram schematically showing the distance measuring camera according to the first embodiment of the present invention. FIG. 2 is a diagram for showing a configuration of a light beam irradiation unit of the distance measuring camera shown in FIG. 1. FIG. 3 is a diagram for explaining a principle of a distance measuring method used in the distance measuring camera shown in FIG. 1. FIG. 4 is a diagram for explaining a relationship between a size of a collimated light beam contained in an image obtained by irradiating the collimated light beam with respect to the subject and photographing the subject and the distance to the subject. FIG. 5 is a diagram for explaining the relationship between the size of the collimated light beam contained in the image obtained by irradiating the collimated light beam with respect to the subject and photographing the subject and the distance to the subject. FIG. 6 is a diagram for explaining a relationship between a change in a shape of the light beam in the obtained image and a change in the distance to the subject.

A distance measuring camera 1 shown in FIG. 1 includes a control part 2 for controlling the distance measuring camera 1, a light beam irradiating unit 3 for irradiating a light beam with respect to a subject, an imaging unit 4 which has an imaging optical system and an image sensor (such as a CCD or CMO image sensor) and photographs the subject to which the light beam is irradiated to obtain an image, an association information storage part 5 for storing association information for associating a size of the light beam on the subject contained in the image with a distance to the subject to which the light beam is irradiated, a distance calculating part 6 for calculating the distance to the subject based on the size of the light beam contained in the image obtained by the imaging unit 4 and the association information stored in the association information storage part 5, a display part 7 such as a liquid crystal panel for displaying arbitrary information, an operation part 8 for inputting operations by a user, a communication part 9 for performing communication with an external device and a data bus 10 for enabling data transmission and reception among each component of the distance measuring camera 1.

The control part 2 performs exchange of various data and various instructions between the components of the distance measuring camera 1 through the data bus 10 to control the distance measuring camera 1. The control part 2 includes a processor for performing operational processes and a memory storing data, programs, modules and the like required for controlling the distance measuring camera 1. The processor of the control part 2 uses the data, the programs, the modules and the like stored in the memory to perform the control of the distance measuring camera 1. The processor of the control unit 2 can provide a desired function by using each component of the distance measuring camera 1. For example, the processor of the control part 2 can use the distance calculating part 6 to perform a process for calculating the distance to the subject based on the size of the light beam on the subject contained in the image obtained by the imaging unit 4.

For example, the processor of the control part 2 is one or more operation units such as microprocessors, microcomputers, microcontrollers, digital signal processors (DSPs), central processing units (CPUs), memory control units (MCUs), graphic processing units (GPUs), state machines, logic circuitries, application specific integrated circuits (ASICs) and combinations thereof that can perform operational processes such as signal manipulation based on computer-readable instructions. Among other capabilities, the processor of the control part 2 is configured to fetch computer-readable instructions (such as data, programs and modules) stored in the memory of the control part 2 and perform signal control and signal manipulation.

The memory of the control part 2 is one or more removable or non-removable computer-readable media including volatile memories (such as RAMs, SRAMs and DRAMs), non-volatile memories (such as ROM, EPROMs, EEPROMs, flash memories, hard disks, optical dicks, CD-ROMs, digital versatile dicks (DVDs), magnetic cassettes, magnetic tapes and magnetic dicks) and combinations thereof. The processor of the control unit 2 can execute the computer readable instructions stored in the memory or use each component of the distance measuring camera 1 to perform various processes required for measuring the distance measuring camera 1.

The light beam irradiation unit 3 has a function as a projector for irradiating a light beam (beam) with respect to the subject. As shown in FIG. 2, the light beam irradiation unit 3 includes a light source 31 for irradiating a single light beam B1, light beam diffusing means 32 (a first diffraction grating) configured to receive the single light beam B1 irradiated from the light source 31 and emit a diffusing light beam B2 and light distribution angle changing means 33 (a second diffraction grating or a collimating lens) configured to change a light distribution angle φ of the diffusing light beam B2 emitted from the light beam diffusing means 32 and emit a light beam B3 that diffuses or converges with the light distribution angles φ which is different from a light converging angle θ of the imaging optical system of the imaging unit 4 or a collimated light beam (a parallel light beam) B3.

In this regard, the term of “the light converging angle θ of the imaging optical system of the imaging unit 4” used in the specification refers to a converging angle (a focusing angle) of light when the light from an arbitrary subject is converged (focused) by the imaging optical system of the imaging unit 4 to form an image of the subject onto the image sensor (an imaging surface) of the imaging unit 4 as shown in FIGS. 3(a) to 3(d). Further, the term of “the light distribution angle φ of the light beam” refers to a diffusion angle or converging angle of the light beam from a main point position of the imaging optical system of the imaging unit 4 as shown in FIGS. 3(a), 3(c), 3(d).

Referring back to FIG. 2, the light source 31 has a function of irradiating the single light beam B1 with respect to the light beam diffusing means 32. The light source 31 is not particularly limited as long as it can irradiate the single light beam B1 with respect to the light beam diffusing means 32. For example, a point light source such as an LED element and a laser oscillator can be used as the light source 31. In this regard, the light beam B1 emitted from the light source 31 is preferably a near infrared light within 940 nm band. Since the near infrared light beam is inconspicuous to the human eye, it is not likely to give discomfort or dislike to the subject when the light beam is irradiated with respect to the subject if the subject is a person. Further, in this case, it is preferable to provide a bandpass filter (not shown) between the light source 31 and the light beam diffusing means 32 for selectively transmitting a near infrared light beam within the 940 nm band. This makes it possible to eliminate a disturbance effect of natural light with respect to the light beam irradiation unit 3.

The light beam diffusing means 32 is provided in front of the light source 31 and is configured to receive the light beam B1 emitted from the light source 31 and emit a diffusing light beam B2. The light beam diffusing means 32 can be constituted of a diffractive grating such as a diffractive optical element (DOE: Diffractive Optical Element) for diffusing light.

The diffusing light beam B2 emitted from the light beam diffusing means 32 is a light beam that diffuses with a predetermined light distribution angle φ. The light distribution angle φ of the diffusion of the diffusing light beam B2 can be appropriately set depending on a separation distance between the light beam diffusing means 32 and the light distribution angle changing means 33, a required diameter of a light beam B3 or the like.

The light distribution angle changing means 33 is configured to change the light distribution angle φ of the diffusing light beam B2 emitted from the light beam diffusing means 32 and emit the light beam B3 that diffuses or converges with the light distribution angle φ which is different from the light converging angle θ of the imaging optical system of the imaging unit 4 or the collimated light beam B3. For example, the light distribution angle changing means 33 can be constituted of a diffractive optical element (DOE) for diffusing or converging a light beam or a collimating lens configured to collimate a light beam.

The light beam B3 emitted from the light distribution angle changing means 33 is a light beam that diffuses or converges with the light distribution angle φ which is different from the light converging angle θ of the imaging optical system of the imaging unit 4 or a collimated light beam. In the distance measuring camera 1 of the present invention, the image is obtained by photographing the subject in a state that the light beam B3 is irradiated with respect to the subject and the distance to the subject is calculated based on a size of the light beam B3 on the subject contained in the obtained image.

Referring to FIGS. 3 to 5, the principles of the distance measuring method used in the distance measuring camera of the present invention will be described. FIG. 3(a) shows the light beam B3 irradiated with respect to the subject when the light converging angle θ of the imaging optical system of the imaging unit 4 is equal to the light distribution angle φ of the diffusion of the light beam B3 (θ=φ).

When the light beam B3 is diffusing light, the light beam B3 emitted from the light beam irradiating unit 3 spreads as a propagation distance of the light beam B3 increases. On the other hand, as is well known, a magnification M of the image of the subject formed on the image sensor (the imaging surface) of the imaging unit 4 by the imaging optical system of the imaging unit 4 changes depending on the distance to the subject (M=b/a, where “a” is the distance from the imaging optical system to the subject and “b” is the distance from the imaging optical system to the image sensor). Therefore, as the distance from the imaging optical system of the imaging unit 4 (the distance measuring camera 1) to the subject increases, the subject in a wider range is reduced with a larger magnification and the image of the subject is formed on the image sensor.

As shown in FIG. 3(a), when the light converging angle θ of the imaging optical system of the imaging unit 4 is equal to the light distribution angle φ of the diffusion of the light beam B3, even if the distance from the distance measuring camera 1 to the subject increases and the range of the subject whose image is formed on the imaging element spreads, the size of the light beam B3 irradiated onto the subject also spreads in the same manner. Therefore, even if the distance from the distance measuring camera 1 to the subject changes, the size of the light beam B3 in the image is constant and does not change when viewing the image obtained by the imaging unit 4. Therefore, as shown in FIG. 3(a), when the light converging angle θ of the imaging optical system of the imaging unit 4 is equal to the light distribution angle φ of the diffusion of the light beam B3, it is impossible to calculate the distance to the subject by referring to the size of the light beam B3 on the subject contained in the image obtained by the imaging unit 4.

On the other hand, in the distance measuring camera 1 of the present invention, the light beam irradiation unit 3 is configured to irradiate the light beam B3 that diffuses or converges with the light distribution angle φ which is different from the light converging angle θ of the imaging optical system of the imaging unit 4 or the collimated light beam B3 with respect to the subject. FIG. 3(b) shows an example in which the collimated light beam B3 is irradiated with respect to the subject. FIG. 3(c) shows an example in which the light beam B3 converging with the light distribution angle φ which is different from the light converging angle θ of the imaging optical system of the imaging unit 4 is irradiated with respect to the subject. FIG. 3(d) shows an example in which the light beam B3 diffusing with the light distribution angle φ which is different from the light converging angle θ of the imaging optical system of the imaging unit 4 is irradiated with respect to the subject.

First, description will be given to the example shown in FIG. 3(b), in which the collimated light beam B3 is irradiated with respect to the subject. Since the light beam B3 in FIG. 3(b) is collimated, the light beam B3 propagates with maintaining a constant size (a constant beam diameter). Namely, as shown in FIG. 4, even if the distance from the imaging optical system of the imaging unit 4 (the distance measuring camera 1) to the subject to which the light beam B3 is irradiated changes, an actual size of the light beam B3 irradiated on the subject does not change.

On the other hand, as described above, as the distance from the imaging optical system of the imaging unit 4 (the distance measuring camera 1) to the subject increases, the subject in the wider range is reduced with the larger magnification and the image of the subject is formed on the image sensor of the imaging unit 4. Therefore, when the subject is photographed by the imaging unit 4 in a state that the collimated light beam B3 is irradiated with respect to the subject by using the light beam irradiation unit 3 to obtain the image, the size of the light beam B3 on the subject contained in the obtained image changes in accordance with the distance to the subject. Specifically, when the subject is located at a near position, the size of the light beam B3 increases in the image obtained by the imaging unit 4. On the other hand, when the subject is located at a far position, the size of the light beam B3 reduces in the image obtained by the imaging unit 4.

FIG. 5 shows a situation that the size of the light beam B3 in the image obtained by the imaging unit 4 changes in accordance with the distance to the subject. FIGS. 5(a) to 5(d) respectively show images obtained by photographing different subjects whose distances from the imaging optical system of the imaging unit 4 (the distance measuring camera 1) are different from each other (distances 1 to 4) in a state that the collimated light beam B3 is irradiated with respect to the subjects as shown in FIG. 4. In this regard, in FIGS. 4 and 5, the distance 1 is a closest distance from the subject to the imaging optical system of the imaging unit 4 (the distance measuring camera 1) and the distance 4 is a farthermost distance from the subject to the imaging optical system of the imaging unit 4 (the distance measuring camera 1). Further, a relationship of “the distance 1<the distance 2<the distance 3<the distance 4” is satisfied.

FIG. 5(a) shows the image obtained by photographing the subject from which the distance to the imaging optical system of the imaging unit 4 (the distance measuring camera 1) is the closest distance 1. In the image shown in FIG. 5(a), since the distance from the subject to the imaging optical system of the imaging unit 4 is relatively small, the area of the image of the subject formed on the image sensor (the imaging surface) of the imaging unit 4 is relatively small and thus the reduction magnification of the image of the subject is also relatively small. On the other hand, since the actual size of the collimated light beam B3 is constant, the size of the light beam B3 in the obtained image is relatively large as shown in FIG. 5(a).

FIG. 5(b) shows the image obtained by photographing the subject from which the distance to the imaging optical system of the imaging unit 4 (the distance measuring camera 1) is the distance 2 larger than the distance 1. In the image shown in FIG. 5(b), the area of the image of the subject formed on the image sensor (the imaging surface) of the imaging unit 4 is wider than the case shown in FIG. 5(a) and the reduction magnification of the image of the subject is also larger than the case shown in FIG. 5(a). On the other hand, as shown in FIG. 5(b), since the actual size of the collimated light beam B3 is constant, the size of the light beam B3 in the obtained image is smaller than that in the case shown in FIG. 5(a).

As is clear from FIG. 5(c) and FIG. 5(d), as the distance from the subject to the imaging optical system of the imaging unit 4 (the distance measuring camera 1) increases, the size of the light beam B3 in the obtained image reduces. Namely, the size of the light beam B3 on the subject contained in the obtained image changes according to the distance from the subject to the imaging optical system of the imaging unit 4 (the distance measuring camera 1). Therefore, by detecting the size of the light beam B3 on the subject contained in the obtained image, it is possible to calculate the distance from the subject to the imaging optical system of the imaging unit 4 (the distance measuring camera 1). The distance measuring camera 1 of the present invention can calculate the distance to the subject by using the above-mentioned principle.

In this regard, the above-mentioned principle can be available for any cases as long as the size of the light beam B3 in the obtained image changes according to the distance from the subject to the imaging optical system of the imaging unit 4 (the distance measuring camera 1). Thus, the light beam B3 is not limited to the collimated light beam as shown in FIG. 3(b). The light beam B3 may be a light beam converging with the light distribution angle φ which is different from the light converging angle θ of the imaging optical system of the imaging unit 4 as shown in FIG. 3(c) or may be a light beam diffusing with the light distribution angle φ which is different from the light converging angle θ of the optical system of the imaging unit 4 as shown in FIG. 3(d).

As shown in FIG. 3(c) and FIG. 3(d), when the light beam B3 diffuses or converges with the light distribution angle φ which is different from the light converging angle θ of the imaging optical system of the imaging unit 4, the actual size (the actual beam diameter) of the light beam B3 changes according to the propagation distance of the light beam B3. However, the change in the actual size of the light beam B3 according to the propagation distance of the light beam B3 is different from the changes in the area and the reduction magnification of the subject according to the distance from the subject to the imaging optical system of the imaging unit 4 (the distance measuring camera 1). Therefore, even in the case as shown in FIG. 3(c) and FIG. 3(d), the size of the light beam B3 in the obtained image changes according to the distance from the subject to the imaging optical system of the imaging unit 4 (the distance measuring camera 1). Therefore, by calculating the size of the light beam B3 on the subject contained in the obtained image, it is possible to calculate the distance from the subject to the imaging optical system of the imaging unit 4 (the distance measuring camera 1).

Further, it is also possible to measure an actual size (an actual height or an actual width) of the subject based on the size of the light beam B3 in the obtained image. As described above, the size of the light beam B3 in the obtained image changes according to the distance from the subject to the imaging optical system of the imaging unit 4 (the distance measuring camera 1). On the other hand, when the light beam B3 is the collimated light beam, since the actual size (the actual beam diameter) of the light beam B3 is constant regardless of the propagation distance of the light beam B3, it is possible to calculate the actual size of the subject by taking a ratio (S2/S1) of the size S1 of the light beam B3 in the image and the size (image height or image width) S2 of the subject contained in the image and multiplying the calculated ratio (S2/S1) by the actual size of the light beam B3.

Further, when the light beam B3 is a light beam that diffuses or converges with the light distribution angle φ which is different from the light converging angle θ of the imaging optical system of the imaging unit 4, the change in the actual size (the actual beam diameter) of the light beam B3 according to the propagation distance of the light beam B3 can be measured or calculated in advance. Therefore, it is possible to calculate the actual size of the subject based on the size of the light beam B3 in the obtained image. Specifically, after calculating the distance from the subject to the imaging optical system of the imaging unit 4 (the distance measuring camera 1) based on the size of the light beam B3 in the obtained image, the actual size of the light beam B3 is calculated by using the calculated distance to the calculated subject. Furthermore, by taking the ratio (S2/S1) of the size S1 of the light beam B3 in the obtained image and the size S2 of the subject contained in the obtained image and multiplying the calculated ratio (S2/S1) by the obtained actual size of the light beam B3, it is possible to calculate the actual size of the subject.

The distance measuring camera 1 of the present invention can calculate the distance to the subject based on the size of the light beam B3 on the subject contained in the obtained image by utilizing the above-mentioned principle. As described above, since the distance measuring camera 1 of the present invention does not use any disparity in order to calculate the distance to the subject, it is possible to arrange the imaging unit 4 and the light beam irradiation unit 3 with being close to each other. Therefore, as compared with the conventional distance measuring camera in which it is necessary to arrange a plurality of imaging systems or an imaging system and a projector with being spaced significantly apart from each other, it is possible to downsize the distance measuring camera 1 of the present invention.

Referring back to FIG. 1, the imaging unit 4 includes the imaging optical system for converging (focusing) light from the subject to which the light beam B3 emitted from the light beam irradiation unit 3 is irradiated and the image sensor for photographing the subject to which the light beam B3 is irradiated to obtain the image. Thus, the imaging unit 4 is used for obtaining the image containing the subject to which the light beam B3 is irradiated.

The imaging unit 4 is arranged so as to be close to the light beam irradiation unit 3 so that an optical axis of the imaging optical system of the imaging unit 4 and an optical axis of the light source 31 of the light beam irradiation unit 3 are parallel to each other. In the distance measuring camera 1 of the present invention, since the optical axis of the imaging optical system of the imaging unit 4 and the optical axis of the light source 31 of the light beam irradiation unit 3 are not located on one axis, the position of the light beam B3 on the subject contained in the image obtained by the imaging unit 4 changes (shifts) according to the distance to the subject.

When the position of the light beam B3 in the image drastically changes according to the distance to the subject, it is required to perform a process for identifying the position of the light beam B3 in the image after obtaining the image with the imaging unit 4. For simplifying the processes of the distance measuring camera 1, it is preferable that the change in the position of the light beam B3 in the image according to the distance to the subject is as small as possible. Therefore, in the distance measuring camera 1 of the present invention, the imaging unit 4 is arranged so that the imaging unit 4 is close to the light beam irradiation unit 3 and the optical axis of the imaging optical system of the imaging unit 4 and the optical axis of the light source 31 of the light beam irradiation unit 3 are parallel to each other.

If the optical axis of the imaging optical system of the imaging unit 4 and the optical axis of the light source 31 of the light beam irradiation unit 3 are not parallel to each other, the change in the position of the light beam B3 in the image according to the distance to the subject increases. Similarly, if a separation distance between the imaging unit 4 and the light beam irradiation unit 3 is large, a distance between the optical axis of the imaging optical system of the imaging unit 4 and the distance between the optical axis of the light source 31 of the light beam irradiation unit 3 also becomes large and thus the change in the position of the light beam B3 in the image according to the distance to the subject increases.

For these reasons, the imaging unit 4 is arranged so that the optical axis of the imaging optical system of the imaging unit 4 and the optical axis of the light source 31 of the light beam irradiation unit 3 are parallel to each other and the imaging unit 4 is as close to the light beam irradiation unit 3 as possible. Further, by arranging the imaging unit 4 with being as close to the light beam irradiation unit 3 as possible, it is possible to downsize the distance measuring camera 1.

The association information storage part 5 is an arbitrary nonvolatile storage medium (such as a hard disk and a flash memory) for storing association information that associates the size of the light beam B3 on the subject contained in the image obtained by the imaging unit 4 with the distance to the subject.

The association information stored in the association information storage part 5 is information for calculating the distance to the subject from the size of the light beam B3 on the subject contained in the image obtained by the imaging unit 4. Specifically, the association information is a data table or a calculation formula for identifying the distance to the subject from the size of the light beam B3 on the subject contained in the image obtained by the imaging unit 4. Such association information is created in advance and stored in the association information storage part 5.

Further, the association information storage part 5 may further store size calculation information for calculating the actual size of the subject from the size of the light beam B3 in the image obtained by the imaging unit 4. Specifically, when the light beam B3 is a collimated light beam, the actual size (the actual beam diameter) of the light beam B3 is stored as the size calculation information. Further, when the light beam B3 diffuses or converges with the light distribution angle φ which is different from the light converging angle θ of the imaging optical system of the imaging unit 4, a data table or a calculation formula for identifying the actual size (the actual beam diameter) of the light beam B3 from the calculated distance to the subject is stored as the size calculation information. By using the size calculation information, it is possible to identify the actual size (the actual beam diameter) of the light beam B3 in the image. If the actual size of the light beam B3 in the image can be identified, by comparing the size of the light beam B3 and the size of the subject in the image, it is possible to calculate the actual size of the subject as described above.

The distance calculating part 6 has a function of calculating the distance to the subject based on the size of the light beam B3 on the subject contained in the image obtained by the imaging unit 4. When the distance calculating part 6 receives the image from the imaging unit 4, the distance calculating part 6 extracts the light beam B3 contained in the received image and detects the size (e.g., the number of pixels) of the light beam B3.

After the distance calculating part 6 detects the size of the light beam B3 on the subject contained in the received image, the distance calculating part 6 calculates the distance to the subject by collating the calculated size of the light beam B3 with the association information stored in the association information storage part 5. Specifically, the distance calculating part 6 calculates the distance to the subject by referring to the calculated size of the light beam B3 and the association information (the data table or the calculation formula) stored in the association information storage part 5.

Further, after the distance calculating part 6 calculates the distance to the subject, the distance calculating part 6 may calculate the actual size of the subject by using the calculated distance to the subject and the size calculation information stored in the association information storage part 5. Specifically, when the light beam B3 is a collimated light beam, the actual size (the actual beam diameter) of the light beam B3 is identified by using the size calculation information and then comparison between the size of the light beam B3 and the size of the subject in the image is performed to calculate the actual size of the subject. Further, when the light beam B3 diffuses or converges with the light distribution angle φ which is different from the light converging angle θ of the imaging optical system of the imaging unit 4, the actual size of the light beam B3 in the image is identified based on the calculated distance to the subject and the size calculation information and then comparison between the size of the light beam B3 and the size of the subject in the image is performed to calculate the actual size of the subject.

In this regard, in a case where a depth of the subject (the distance from the distance measuring camera 1) changes in the area of the subject to which the light beam B3 is irradiated, the shape of the light beam B3 in the image changes as shown in FIG. 6(a) and FIG. 6(b). FIG. 6(a) shows an example of the change in the shape of the light beam B3 in the image in a case where the depth of the subject discontinuously changes in the area of the subject to which the light beam B3 is irradiated. FIG. 6(b) shows an example of the change in the shape of the light beam B3 in the image in a case where the depth of the subject continuously changes in the area of the subject to which the light beam B3 is irradiated.

In the example of FIG. 6(a), as shown in the upper side of FIG. 6(a), the depth of the area of the subject to which the light beam B3 is irradiated discontinuously increases. In this case, the shape of the light beam B3 in the image discontinuously changes as shown in the lower side of FIG. 6(a). In the example of FIG. 6(b), as shown in the upper side of FIG. 6(b), the depth of the area of the subject to which the light beam B3 is irradiated continuously increases. In this case, the shape of the light beam B3 in the image continuously changes as shown in the lower side of FIG. 6(b). When the distance calculating part 6 detects the size of the light beam B3 on the subject contained in the received image, the distance calculating part 6 may be configured to identify the change in the shape of the light beam B3 and detect the change in the depth of the area of the subject (the distance from the distance measuring camera 1) to which the light beam B3 is irradiated based on the identified change in the shape of the light beam B3.

Referring back to FIG. 1, the display part 7 is a panel-type display unit such as a liquid crystal display unit. The image obtained by the imaging unit 4, the distance to the subject calculated by the distance calculating part 6, information for operating the distance measuring camera 1 or the like are displayed on the display part 7 in the form of a character or an image in response to a signal from the processor of the control part 2.

The operation part 8 is used by the user of the distance measuring camera 1 to perform operations. The operation part 8 is not particularly limited as long as the user of the distance measuring camera 1 can perform the operations. For example, a mouse, a keyboard, a ten-key pad, a button, a dial, a lever, a touch panel, or the like can be used as the operation part 8. The operation part 8 transmits signals respectively corresponding to the operations from the user of the distance measuring camera 1 to the processor of the control part 2.

The communication part 9 has a function of inputting data into the distance measuring camera 1 and/or outputting data from the distance measuring camera 1 to external devices. The communication part 9 may be connected to a network such as the Internet. In this case, the distance measuring camera 1 can communicate with an external device such as an externally provided web server or data server by using the communication part 9.

Although the light beam irradiation unit 3 includes one light source 31, one light diffusing means 32 and one light distribution angle changing means 33 in the present embodiment, the present invention is not limited thereto. For example, an aspect in which the light beam irradiation unit 3 includes a plurality of light sources 31, a plurality of light diffusing means 32 and a plurality of light distribution angle changing means 33 is also involved in the scope of the present invention.

### Second Embodiment

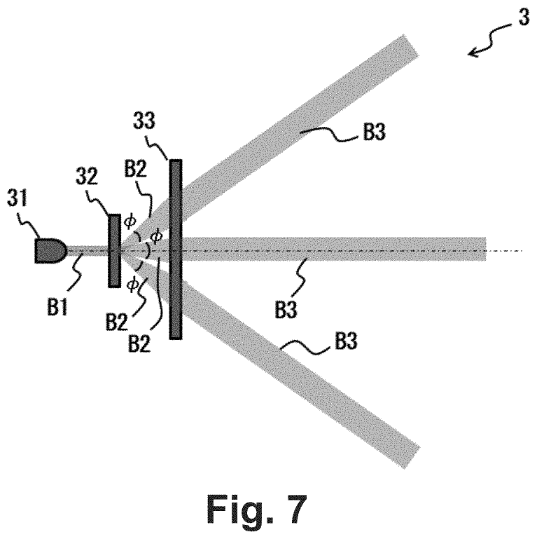

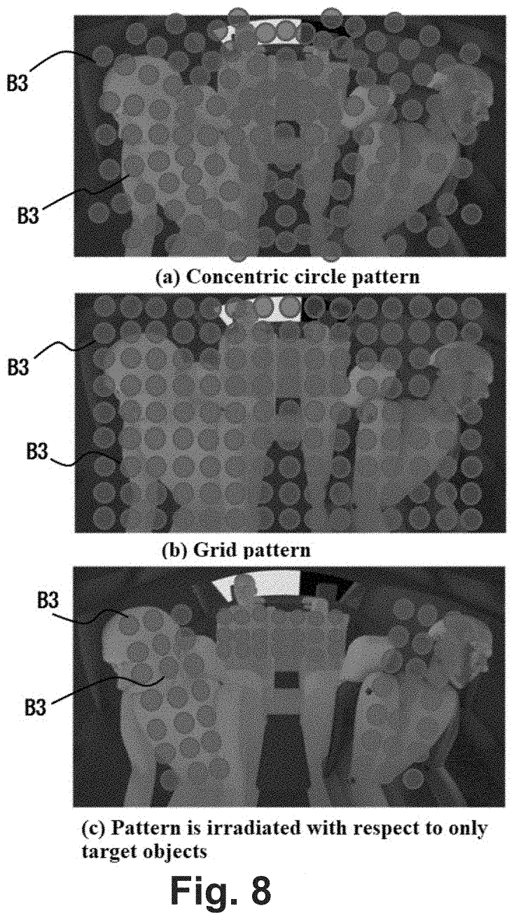

Next, a distance measuring camera 1 according to a second embodiment of the present invention will be described in detail with reference to FIG. 7 and FIG. 8. FIG. 7 is a diagram showing the configuration of the light beam irradiation unit of the distance measuring camera according to the second embodiment of the present invention. FIG. 8. is a diagram showing an example of a pattern of light beams irradiated with respect to the subjects used in the distance measuring camera shown in FIG. 7.

Hereinafter, the distance measuring camera 1 of the second embodiment will be described by placing emphasis on the points differing from the distance measuring camera 1 of the first embodiment with the same matters being omitted from the description. The distance measuring camera 1 of the second embodiment is the same as the distance measuring camera 1 of the first embodiment except that the configuration of the light beam irradiation unit 3 is changed.

As shown in FIG. 7, the light beam irradiating unit 3 of the distance measuring camera 1 according to the second embodiment of the present invention is configured to irradiate a plurality of light beams B3 with respect to the subjects. In the present embodiment, the light beam diffusing means 32 (the first diffraction grating) is configured to receive the single light beam B1 and emit a plurality of diffusing light beams B2. Further, the light distribution angle changing means 33 (the second diffraction grating or the collimating lens) is configured to change the light distribution angle φ of each of the plurality of diffusing light beams B2 and emit the plurality of light beams B3 each of which diffuses or converges with the light distribution angle φ which is different from the light converging angle θ of the imaging optical system of the imaging unit 4 or a plurality of collimated light beams B3.

The single light beam B1 emitted from the light source 31 is converted into the plurality of diffusing light beams B2 propagating toward different directions by the light beam diffusing means 32. The light distribution angle changing means 33 converts the light distribution angle φ of each of the plurality of diffusing light beams B2 propagating toward the different directions and emit the plurality of light beams B3 propagating toward the different directions to the subjects.

In the present embodiment, it is possible to irradiate the plurality of light beams B3 by using the light beam irradiating unit 3 having the above-mentioned configuration. Therefore, the distance measuring camera 1 of the present embodiment can calculate distances from the distance measuring camera 1 to a plurality of sample points (points to which the plurality of light beams B3 are respectively irradiated). Further, the distance measuring camera 1 of the present embodiment can calculate the distances to the plurality of sample points. Thus, even when a plurality of subjects are contained in the image obtained by the imaging unit 4, the distance measuring camera 1 of the present embodiment can calculate the distance to each of the plurality of subjects from one image.

The number of the plurality of diffusing light beams B2 emitted from the light beam diffusing means 32 is not particularly limited and can be appropriately set depending on the number of the sample points required for calculating the distance(s) to the subject(s) using the image obtained by the imaging unit 4.

Further, the light beam diffusing means 32 and the light distribution angle changing means 33 of the light beam irradiation unit 3 of the present embodiment are configured and arranged so that the plurality of light beams B3 irradiated with respect to the subjects form a predetermined pattern in the image obtained by the imaging unit 4. FIG. 8(a) to FIG. 8(c) show examples of the image obtained by the imaging unit 4 when the distance measuring camera 1 of the present embodiment is provided in a vehicle in order to identify the number and poses of occupants in the vehicle.

In the example shown in FIG. 8(a), the plurality of light beams B3 form a concentric circle pattern in the image. On the other hand, in the example shown in FIG. 8(b), the plurality of light beams B3 form a grid pattern in the image. As described above, by configuring and arranging the light beam diffusing means 32 and the light distribution angle changing means 33 of the light beam irradiation unit 3 so that the plurality of light beams B3 form the concentric circle pattern or the grid pattern in the image, it is possible to substantially uniformly deploy the sample points for which the distances are calculated in the image. As a result, it becomes possible to obtain more distance information from one image obtained by the imaging unit 4. Since many distance information can be calculated in this manner, the number of occupants, the attitude of each occupant and the like can be detected based on one image and the distance information.

In addition, target objects (subjects) for which the distances need to be calculated in order to identify the number of the occupants and the attitude of each occupant in the vehicle are mainly the occupants sitting in seats. When the distance measuring camera 1 is fixedly installed in the vehicle, positions of the seats on which the occupants respectively sit are substantially fixed in the image obtained by the imaging unit 4. Therefore, it is sufficient to irradiate the pattern of the light beams B3 with respect to the seats for detecting the number of the occupants, the attitude of each occupant and the like. In the example shown in FIG. 8(c), the pattern of the light beams B3 is irradiated with respect to only the seats where the occupants can seat.

As described above, when the position of the target object (subject) for which the distance needs to be calculated does not drastically change and is known in advance, a predetermined purpose can be achieved by irradiating the pattern of the light beams B3 with respect to only the target object (subject) for which the distance needs to be calculated. Thus, by configuring and arranging the light beam diffusing means 32 and the light distribution angle changing means 33 of the light beam irradiation unit 3 so as to irradiate the pattern of the light beams B3 with respect to only the target object (subject) for which the distance needs to be calculated, it becomes possible to reduce the number of the sample points for which the distance is calculated and reduce the calculation amount of the distance measuring camera 1.

As described in detail herein, the distance measuring camera 1 of the present invention can calculate the distance to the subject based on the size of the light beam B3 on the subject contained in the obtained image. Since the distance measuring camera 1 of the present invention does not use any disparity to calculate the distance to the subject, it is possible to arrange the imaging unit 4 and the light beam irradiation unit 3 with being close to each other. Therefore, as compared with the conventional distance measuring camera required to arrange a plurality of imaging systems or an imaging system and a projector with being spaced significantly apart from each other, it is possible to downsize the distance measuring camera 1 of the present invention.

### Distance Measuring Method

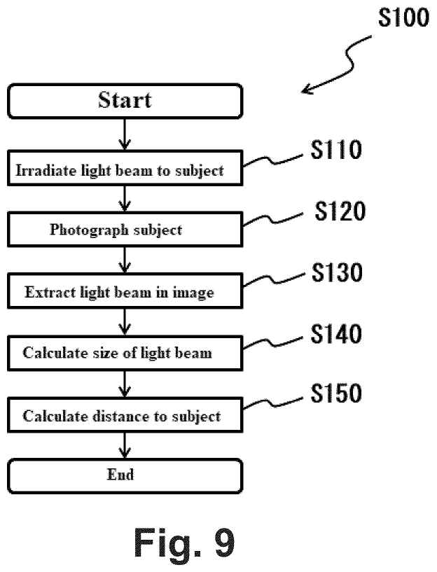

Next, referring to FIG. 9, the distance measuring method performed by using the distance measuring camera of the present invention will be described. FIG. 9 is a flow chart illustrating the distance measuring method performed by using the distance measuring camera of the present invention. Although the distance measuring method described below can be performed by using the distance measuring camera 1 of the present invention and an arbitrary device having the same function as that of the distance measuring camera 1 of the present invention described above, for the sake of explanation, it is assumed that the distance measuring method is performed by using the distance measuring camera 1.

The distance measuring method S100 shown in FIG. 9 is started when the user of the distance measuring camera 1 uses the operation part 8 to perform operations for measuring the distance to the subject or the communication part 9 of the distance measuring camera 1 receives a measuring start signal from another device.

In a step S110, the light beam B3 is irradiated with respect to the subject from the light beam irradiation unit 3. Next, in a step S120, the subject to which the light beam B3 is irradiated is photographed by the imaging unit 4 to obtain the image. In a step S130, the distance calculating part 6 receives the image from the imaging unit 4 and extracts the light beam B3 on the subject contained in the image. Thereafter, in a step S140, the distance calculating part 6 calculates the size (e.g., the number of pixels) of the extracted light beam B3. In a step S150, the distance calculating part 6 calculates the distance to the subject by collating the calculated size of the light beam B3 with the association information stored in the association information storage part 5. When the distance to the subject is calculated in the step S150, the calculated distance to the subject is displayed on the display part 7 or transmitted to an external device by the communication part 9 and then the distance measuring method S100 ends.

In this regard, in the step S150, after the distance to the subject is calculated, a step of calculating the actual size of the subject and/or a step of determining whether or not the change in the depth exists in the area to which the light beam B3 is irradiated may be performed by the distance calculating part 6. This aspect is also involved in the distance measuring method performed by using the distance measuring camera 1 of the present invention.

Although the distance measuring camera of the present invention has been described based on the embodiments shown in the drawings, the present invention is not limited thereto. Each configuration of the present invention can be replaced by any configuration capable of performing the same function or any configuration can be added to each configuration of the present invention.

For example, the number and the types of the components of the distance measuring camera 1 shown in FIG. 1 are merely illustrative example and the present invention is not necessarily limited thereto. An aspect in which any components have been added, combined or omitted for any purpose without departing from the principles and the intent of the present invention is also involved within the scope of the present invention. Further, each component of the distance measuring camera 1 may be realized by hardware, software, or a combination thereof.

In addition, the number and the types of the steps of the distance measuring method S100 shown in FIG. 9 are merely illustrative examples and the present invention is not necessarily limited thereto. An aspect in which any steps have been added, combined or omitted for any purpose without departing from the principles and the intent of the present invention is also involved within the scope of the present invention.

### Examples of Application

Examples of application of the distance measuring camera 1 of the present invention are not particularly limited. For example, as described above with reference to FIG. 8, the distance measuring camera 1 of the present invention can be applied for an occupant and attitude detection system for identifying the number of occupants and the attitude of each occupant in a vehicle.

In this case, the distance measuring camera 1 is fixedly provided at a predetermined position in the vehicle and photographs the subjects to which the light beams B3 are irradiated at an arbitrary timing instructed by an operation from the user, a measuring start signal from another device or the like to measure the distance to the subject.

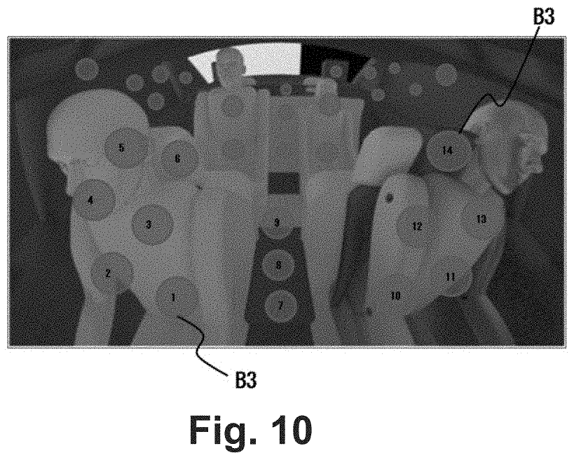

FIG. 10 shows an example of the image obtained by using the distance measuring camera 1 of the present invention applied for the occupant and attitude detection system. In the example shown in FIG. 10, the plurality of light beams B3 are irradiated with respect to a plurality of subjects. As shown in FIG. 10, an ID number is given to each of the plurality of light beams B3 and the size of each light beam B3 identified by the ID number is detected by the distance calculating part 6 of the distance measuring camera 1. In FIG. 10, for simplicity of the drawings, the ID numbers of the light beams B3 irradiated to a rear seat have been omitted. However, the ID numbers are also given to the light beams B3 irradiated to the rear seat in practice.

By obtaining such an image with the distance measuring camera 1, the distances from the distance measuring camera 1 to the plurality of sample points (subjects) which are respectively identified by the ID numbers and to which the plurality of light beams B3 are irradiated are calculated. By combining information on the calculated distances to the plurality of sample points, it is possible to estimate the presence or absence of the occupant and the attitude of the occupant.

For example, by referring to the distances to the sample points which are respectively identified by the ID numbers 1 to 6 and to which the light beams B3 are irradiated in FIG. 10, it is possible to estimate the presence or absence of the occupant or the attitude of the occupant existing on the front left side in the drawing. Further, by referring to the distances to the sample points which are respectively identified by the ID numbers 10 to 14 and to which the light beams B3 are irradiated in FIG. 10, it is possible to estimate the presence or absence of the occupant or the attitude of the occupant existing on the front right side in the drawing.

Further, the distance measuring camera 1 of the present invention can be used to obtain a three-dimensional image of a face of the subject as well as photograph a portrait image of the subject. In such an application aspect, it is preferable to incorporate the distance measuring camera 1 of the present invention into a mobile device such as a smart phone or a mobile phone. As described above, since the distance measuring camera 1 of the present invention can be downsized in comparison with the conventional distance measuring camera, it is easy to incorporate the distance measuring camera 1 of the present invention into a small mobile device.

Further, the distance measuring camera 1 of the present invention can be applied for a handler robot used for assembling and inspecting a precision device. According to the distance measuring camera 1, since it is possible to measure a distance from an arm or a main body of the handler robot to the precision device or parts thereof when assembling the precision device, it becomes possible to allow a gripping portion of the handler robot to accurately grip the parts.

Further, since the distance measuring camera 1 of the present invention can measure the distance to the subject, it is possible to obtain the three-dimensional information of the subject. Such three-dimensional information of the subject can be used for forming a three-dimensional structure by a 3D printer.

Further, by utilizing the distance measuring camera 1 of the present invention for a vehicle, it is possible to measure a distance from the vehicle to any object such as a pedestrian or an obstacle. Information on the calculated distance to any object can be used for automatic braking systems and automatic driving of the vehicle.

Although the examples of application of the distance measuring camera 1 of the present invention have been described above, the application of the distance measuring camera 1 of the present invention is not limited to the above-described examples. The distance measuring camera 1 and the distance measuring method S100 of the present invention may be utilized in a variety of applications that are contemplated by those skilled in the art.

### INDUSTRIAL APPLICABILITY

According to the distance measuring camera of the present invention, it is possible to calculate the distance to the subject based on the size of the light beam on the subject contained in the obtained image. Since the distance measuring camera of the present invention does not use any disparity to calculate the distance to the subject, it is possible to arrange the imaging unit for photographing the subject and the light beam irradiation unit for irradiating the light beam with respect to the subject with being close to each other. Therefore, as compared with the conventional distance measuring camera in which it is necessary to arrange a plurality of imaging systems or an imaging system and a projector with being spaced significantly apart from each other, it is possible to downsize the distance measuring camera of the present invention. Thus, the present invention has industrial applicability.

1. A distance measuring camera, comprising;
a light beam irradiation unit for irradiating a light beam with respect to a subject;
an imaging unit for photographing the subject to which the light beam is irradiated to obtain an image; and
a distance calculating part for calculating a distance to the subject based on a size of the light beam on the subject contained in the image obtained by the imaging unit.

2. The distance measuring camera as claimed in claim 1, further comprising an association information storage part for storing association information for associating the size of the light beam on the subject contained in the image with the distance to the subject to which the light beam is irradiated,
wherein the distance calculating part calculates the distance to the subject based on the size of the light beam on the subject contained in the image and the association information stored in the association information storage part.

3. The distance measuring camera as claimed in claim 1, wherein the light beam irradiated with respect to the subject from the light beam irradiating unit is a light beam that diffuses or converges with a light distribution angle which is different from a light converging angle of an imaging optical system of the imaging unit or a collimated light beam.

4. The distance measuring camera as claimed in claim 3, wherein the light beam irradiation unit includes:
a light source for irradiating a single light beam,
a light beam diffusing part configured to receive the single light beam irradiated from the light source and emit a diffusing light beam, and
a light distribution angle changing part configured to change a light distribution angle of the diffusing light beam emitted from the light beam diffusing part and emit the light beam that diffuses or converges with the light distribution angle which is different from the light converging angle of the imaging optical system of the imaging unit or the collimated light beam.

5. The distance measuring camera as claimed in claim 4, wherein the light beam diffusing part is a first diffraction grating configured to convert the single light beam into the diffusing light beam, and
the light distribution angle changing part is a second diffraction grating configured to change the light distribution angle of the diffusing light beam and emit the light beam that diffuses or converges with the light distribution angle which is different from the light converging angle of the imaging optical system of the imaging unit or a collimating lens configured to emit the collimated light beam.

6. The distance measuring camera as claimed in claim 4, wherein the imaging unit and the light beam irradiation unit are arranged close to each other so that an optical axis of the imaging optical system of the imaging unit and an optical axis of the light source of the light beam irradiation unit are parallel to each other.

7. The distance measuring camera as claimed in claim 1, wherein the light beam is a near-infrared light beam.

8. The distance measuring camera as claimed in claim 1, wherein the light beam irradiating unit is configured to irradiate a plurality of light beams with respect to the subject.

9. The distance measuring camera as claimed in claim 8, wherein the plurality of light beams are irradiated so as to form a concentric circle pattern or a grid pattern.
